(19) United States
(12) Patent Application Publication
(10) Pub. No.: US 2024/0321286 A1
(43) Pub. Date: Sep. 26, 2024

(54) Systems and Methods for Audio Preparation and Delivery

(71) Applicant: Super Hi-Fi, LLC, Los Angeles, CA (US)

(72) Inventors: Brendon Patrick Cassidy, Venice, CA (US); Zack J. Zalon, Sherman Oaks, CA (US)

(21) Appl. No.: 18/189,764

(22) Filed: Mar. 24, 2023

(51) Int. Cl. G10L 21/007; G10L 17/02; G10L 21/028; G10L 25/18; G10L 25/30

(52) U.S. Cl. CPC G10L 21/007; G10L 17/02; G10L 21/028; G10L 25/18; G10L 25/30

(57) ABSTRACT

The present application relates to systems and methods for audio preparation and delivery. Such systems and methods may involve a controller configured to carry out operations. The operations include receiving source audio comprising a vocal portion. The operations also include selecting, using a trained machine learning model, a primary voice profile based on an analysis of the vocal portion of the received source audio. The primary voice profile is selected from a plurality of predetermined voice profiles. The operations also include adjusting, based on the selected primary voice profile, at least a portion of the source audio. The operations also include providing output audio based on the adjusted portion of source audio.

### BACKGROUND

Vocal content, for use in various audio applications such as disc jockeying (DJ), audio narration, voice overs, podcasting, Foley, music, etc. can be recorded in professional studios, home studios, or in other non-studio locations. While recording in a professional studio may provide consistent, high quality, broadcast standard vocal content, recordings made in home studios or in remote locations can often provide an inconsistent, amateurish, and unprofessional product. For example, the levels of noise, distortion, plosives, and/or the overall amplitude can vary greatly from one recording to another due to variations in recording hardware/software type, microphone type/positioning, background noise sources, dynamic range, intelligibility, vocal presence, existence of annoying performance artifacts (e.g., mouth sounds or over-emphasized esses), among other factors. Environmental factors such as chirping birds, lawn mowers, traffic, sirens, and other ambient sounds can often lead to sub-broadcast standard audio content.

The proper production of such audio source material, called “mastering” in the industry, requires a specific level of skill, training, experience, and attention to detail. While advancements in recording technologies have made the tools available to even hobbyist voice talent, some efforts to master their own recordings can render the audio even more defective in some instances. Accordingly, there is a need for methods and systems for audio processing that can accept a wide variety of vocal content recordings from very different recording setups and environmental conditions and provide consistent, professional-studio quality and broadcast-quality vocal audio output.

### SUMMARY

Example embodiments relate to systems and methods for audio preparation and delivery. As an example, systems and methods herein may include analyzing audio for various characteristics and determining a) if a particular remediation is necessary (e.g. noise removal, deessing, etc.), b) how much “standard” processing is necessary (e.g. how much dynamic range compression to add), and c) which timbral profile to apply (for example based on determining a selected voice profile). In some embodiments, the selected voice profile may affect other processing choices (e.g. selecting an amount of compression to apply based on a desired level of “naturalness”) and can enable/disable capabilities based on accompanying metadata (e.g. skip the excitation step).

Put another way, the systems and methods described herein analyze an audio signal, identify the type and/or degree of needed/desired adjustment, and then adjust the audio signal accordingly. Identifying the type and/or degree of audio adjustment may include various methods such as: audio feature analysis (e.g. amplitudes over time), custom detection processing (for example, using a histogram and spectrogram to identify moments in the audio where it hard clips or areas of sample concentration that may indicated soft-clipping), or using machine learning (for example, a convolutional neural network that identifies the recording source like dynamic microphone, voice over IP recording, telephone call, etc.). The outputs of such analysis methods could be used to adjust parameters in an associated processor module, guided by the current profile and/or default settings. In some examples, one or more of the processing modules could be driven exclusively or partially by this type of analysis. Alternatively, one or more of the processing modules could be adjusted by a transformational neural network, which could be trained using techniques like differentiable digital signal processing (DDSP).

In a first aspect, an audio preparation and delivery system is provided. The audio preparation and delivery system includes a controller having at least one processor and a memory. The at least one processor executes program instructions stored in the memory so as to carry out operations. The operations include receiving source audio comprising a vocal portion. The operations also include selecting, using a trained machine learning model, a primary voice profile based on an analysis of the vocal portion of the received source audio. The primary voice profile is selected from a plurality of predetermined voice profiles. The operations also include adjusting, based on the selected primary voice profile, at least a portion of the source audio. The operations yet further include providing output audio based on the adjusted portion of source audio.

In a second aspect, a method of training a machine learning model is provided. The method includes receiving a recording from a recording dataset. The method also includes providing a first version and a second version of the recording. The method further includes adjusting the first version of the recording with a first configuration of an audio processing module of a processing chain to provide an input sample. The method yet further includes adjusting the second version of the recording with a second configuration of the audio processing module in the processing chain to provide a reference sample. The method additionally includes encoding the input sample and the reference sample with a convolutional neural network encoder to provide an encoded input sample and an encoded reference sample. The method also includes determining control parameters by way of a controller network. The method further includes determining adjusted control parameters by way of a backpropagation and gradient descent technique to provide a trained machine learning model.

In a third aspect, a method of adjusting source audio is provided. The method includes receiving source audio including a vocal portion. The method also includes selecting, using a trained machine learning model, a primary voice profile based on an analysis of the vocal portion of the received source audio. The primary voice profile is selected from a plurality of predetermined voice profiles. The method additionally includes adjusting, based on the selected primary voice profile, at least a portion of the source audio. The method yet further includes providing output audio based on the adjusted portion of source audio.

Other aspects, embodiments, and implementations will become apparent to those of ordinary skill in the art by reading the following detailed description, with reference where appropriate to the accompanying drawings.

### BRIEF DESCRIPTION OF THE FIGURES

FIG. 1 illustrates an audio preparation and delivery system, according to an example embodiment.

FIG. 2 illustrates audio processing modules, according to an example embodiment.

FIG. 3 illustrates pre-processing modules, according to an example embodiment.

FIG. 4 illustrates a scenario including a processing chain with a plurality of pre-processing modules and audio processing modules, according to an example embodiment.

FIG. 5 illustrates a chart including predetermined voice profiles, according to an example embodiment.

FIG. 6 illustrates a method of training a machine learning model, according to an example embodiment.

FIG. 7 illustrates a method of adjusting source audio, according to an example embodiment.

### DETAILED DESCRIPTION

Example methods, devices, and systems are described herein. It should be understood that the words “example” and “exemplary” are used herein to mean “serving as an example, instance, or illustration.” Any embodiment or feature described herein as being an “example” or “exemplary” is not necessarily to be construed as preferred or advantageous over other embodiments or features. Other embodiments can be utilized, and other changes can be made, without departing from the scope of the subject matter presented herein.

Thus, the example embodiments described herein are not meant to be limiting. Aspects of the present disclosure, as generally described herein, and illustrated in the figures, can be arranged, substituted, combined, separated, and designed in a wide variety of different configurations, all of which are contemplated herein.

Further, unless context suggests otherwise, the features illustrated in each of the figures may be used in combination with one another. Thus, the figures should be generally viewed as component aspects of one or more overall embodiments, with the understanding that not all illustrated features are necessary for each embodiment.

### I. Overview

The present disclosure relates to systems and methods for: 1) receiving source audio signals that may include human voice tracks and/or text-to-speech (TTS) output; and 2) processing the source audio signals via one or more audio processing modules so as to provide output audio that conforms to a predetermined audio quality standard. In some embodiments, systems and methods described herein may be configured to receive unprocessed or pre-processed audio signals. The disclosed systems and methods also include determining an extent and type of needed/desired audio processing. Yet further, the systems and methods described herein may be configured to perform source-separation to extract and process the human voice audio content independently of the other audio in the recording (e.g. background music, sound effects, etc.).

As an example, the audio processing modules may include modules configured to perform one or more functions to adjust one or more substantive properties of the input audio, including: noise reduction, timbre management, de-essing, plosive reduction, voice profiling, dynamic compression, silence trimming, adaptive limiting, speaker extraction, selective excitation, spectral reconstruction, upsampling, de-reverb, de-clipping, channel selection, breath reduction, artifact reduction, gain optimization, de-muxing, speech-to-text, sentiment analysis, thematic segmentation, and/or batch processing.

Additionally or alternatively, one or more pre-processing modules are contemplated. In such scenarios, the pre-processing modules could be configured to perform various preliminary functions in preparation to make subsequent, substantive adjustments to the input audio. As an example, the pre-processing modules could be configured to perform file format conversion, annotation (e.g., adding in-line cues or timestamps), sub-file extraction (e.g., based on the added or existing annotations in the audio file), mono-to-stereo conversion, stereo-to-mono conversion, multi-track-to-stereo conversion, source audio file generation, voice analysis/profiling, noise profiling, and voice diarization among other possibilities. As an example, the pre-processing modules could be configured to spatially reposition the input audio by modifying a stereo field or a three-dimensional imaginary soundstage in two-channel binaural format or in a multichannel format (e.g., Dolby Atmos).

The functions of one or more of the audio processing modules and/or pre-processing modules could include the application of one or more trained machine learning models. As an example, the machine learning model could be trained based on a training data set that includes a plurality of tagged data pairs. For example, to train a supervised machine learning model to perform de-essing on a source audio signal, 10, 100, 1000 or more tagged data pairs could be used to iteratively optimize an objective function that is configured to remove esses from a spoken audio track. In such scenarios, the tagged data pairs could include examples of audio tracks “before and after” production-quality de-essing processing to remove sibilants. Other types of tagged data pairs are possible and contemplated for the purpose of training the several audio processing modules described herein.

In various examples, the machine learning algorithms could be implemented using an artificial neural network (ANN), such as a convolutional neural network (CNN). In some embodiments, the CNN could implement a long short-term memory (LSTM) algorithm. In such scenarios, the LSTM algorithm could include a cell, an input gate, an output gate and a forget gate.

In an example embodiment, the machine learning algorithms and/or models could be based at least in part on the MUSICNN library, which includes a set of pre-trained musically motivated convolutional neural networks for music audio tagging. In some other examples, a demuxing/demixing functionality could be performed using the Demucs architecture. As an example, a mixed multiple track recording could be demixed into its constituent sources (e.g., drums, bass, guitar, and vocals) by performing a hybrid waveform/spectrogram domain source separation. It will be understood that other machine learning algorithms and corresponding libraries could be specifically utilized to perform various tasks. For example, a first library could be used for music analysis and a second library could be utilized to analyze speech-related content.

Yet further models may include neural audio synthesis models such as Differentiable Digital Signal Processing (DDSP), which enables direct integration of classic signal processing elements with deep learning methods. In some DDSP examples, a user may be able to process an audio recording based on a desired styles, desired standards, or other desired aspects to attain similar quality to that of a recording in a professional studio. In such a manner, speech post-production and/or music post-production is possible by adjusting dry content based on a desired style reference.

In some embodiments, the basic audio production process could include a multi-step process: 1) an analysis of the input recording is conducted; 2) an acoustic goal (style) can be established based on the initial analysis and context; and 3) digital signal processing controls may be manipulated to achieve the acoustic goal. In some examples, DDSP can be performed in a self-supervised manner. In such a scenario, a neural network can be trained to emulate a given digital signal processing effect (e.g., parametric equalizer, compressor) such an “emulator” neural network can be referred to as a “neural proxy” for the given DSP. At inference time, a deep neural network and the neural proxy can be used to process audio instead of using the actual DSP effect. Additionally or alternatively, a gradient approximation method could be used to process audio using a simultaneous perturbation stochastic approximation (SPSA) technique. As an example, a parametric EQ DSP effect could be approximated using an infinite impulse response (IIR) filter and a compressor could be approximated using a finite impulse response (FIR) filter in the frequency domain.

Additionally or alternatively, the various machine learning techniques could include a deep learning technique that utilizes a plurality of hidden layers in an artificial neural network. In such a deep learning technique, each hidden layer may learn to transform its input data into a slightly more abstract and composite representation of the source audio signal before adjusting one or more properties of the source audio signal and then reconstructing the audio signal to form the output signal. In some embodiments, the raw input data may include a series of frames of spectral audio amplitude data (e.g., sound amplitude versus frequency). As an example, the frames could include information about the input audio over a 10 ms period. In such scenarios, each frame could represent the input audio as a short-term power spectrum of a given sound environment (e.g., a Mel-frequency cepstrum (MFC) or a cepstrum). In some embodiments, the power spectrum could be represented by a plurality of coefficients (e.g., Mel-frequency cepstral coefficients (MFCCs)). Other formats and representations of the raw input data are possible and contemplated.

Various supervised machine learning techniques are contemplated and possible, including, for example, regression, classification, similarity learning, and active learning. It will be understood that other machine learning techniques, such as unsupervised learning, semi-supervised learning, and/or reinforcement learning processes are possible and contemplated.

Among many other possibilities, the systems and methods described herein could include various machine learning models, such as a rule-based DSP (RB-DSP), a conditional temporal convolutional network (xTCN), a neural proxy (NP), a neural proxy half-hybrid (NP-HH), a neural proxy full-hybrid (NP-FH), a gradient approximation (SPSA), and/or an automatic differentiation (AD) model. Other types of ML models are possible and contemplated.

Some or all of these ML models can be trained using multi-resolution STFT loss with multiple different window sizes. Other training methods are possible and contemplated. The training datasets may include LibriTTS (for speech) or MTG-Jamendo (for music). Other training datasets, including those based on in-house proprietary datasets and/or various types of open source licenses, are possible and contemplated.

In some embodiments, the source audio signals may be processed according to a predetermined or dynamically customizable processing chain. In such scenarios, the processing chain could include various arrangements of the audio processing modules such that order of the modules along the processing chain could be adjusted based on, for example, an initial evaluation of the source audio signal. The initial evaluation of the source audio signal may be performed using a combination of various techniques for relevant information retrieval, such as, but not limited to, time-based digital signal processing, Fourier analysis, machine learning algorithms, among other possibilities. The initial evaluation of the source audio signal could include, among other possibilities, an analysis of an average volume level of a voice track and/or background music track, noise profile, signal clipping, speaker voice profile, and speaker plosives, among other considerations.

In various examples, the predetermined audio quality standard could be based on predetermined values, ranges, and/or thresholds for various audio signal characteristics such as: signal to noise ratio, signal clipping, speaker track to background music track volume ratio, silence duration, breath volume, speaker voice profile, background music track volume, background music track lead-in time, background music genre, and/or background music track tempo, among other possibilities. In some example embodiments, the processed output audio could be analyzed via a post-processing quality control module to confirm that the processed output audio meets or surpasses the predetermined audio quality standard.

In some embodiments, a variety of metrics may be generated based on the unprocessed and/or processed audio signals. In such scenarios, the metrics could include information about signal features including: amplitude over time, pitch of utterance, “onsets” (e.g., times at which sound events start), which speaker is talking, when the speakers pause, when the speakers take breaths, what the frequency response of the recording is, etc. In some examples, such metrics may be utilized beneficially when combining the unprocessed and/or processed audio with other audio (other voice performances, background music, etc.). In other examples, the metrics could be utilized to train the machine learning models described herein. As an example, one or more metrics of the unprocessed and/or processed audio signals could be beneficially help train the machine learning models to provide improved play-out behavior when, for example, assembling multiple voice tracks into a single segment and/or integrating the voice track(s) with sound effects, background music, and/or other audio production elements.

### II. Example Audio Preparation and Delivery Systems

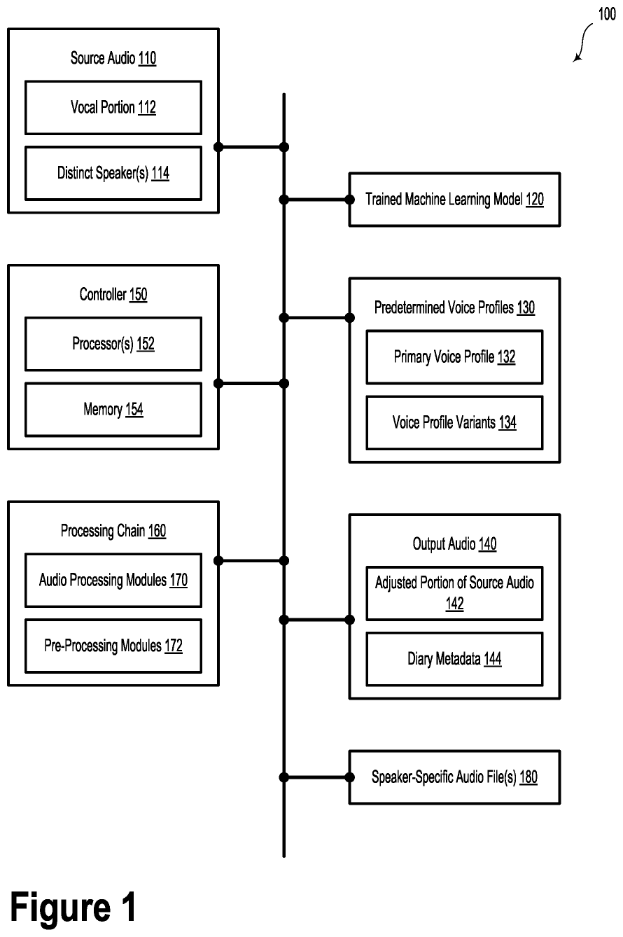

FIG. 1 illustrates an audio preparation and delivery system 100, according to an example embodiment.

The audio preparation and delivery system 100 includes a controller 150 having at least one processor 152 and a memory 154, wherein the at least one processor 152 executes program instructions stored in the memory 154 so as to carry out operations. The operations include receiving source audio 110 having a vocal portion 112.

The operations additionally include selecting, using a trained machine learning model 120, a primary voice profile 132 based on an analysis of the vocal portion 112 of the received source audio 110. The primary voice profile 132 is selected from a plurality of predetermined voice profiles 130. In some example embodiments, the plurality of predetermined voice profiles 130 could include at least one of: bass, baritone, tenor, alto, mezzo, soprano, or child. Additionally or alternatively, the voice profiles selected for a given speaker (e.g., voice actor/talent) could include defined, specific profiles based on at least one of: a) receiving a voice profile preference; b) identifying a voice portion of the received source audio and matching it with an appropriate voice profile; c) selecting the voice profile that is most similar to the voice portion of the received source audio. In such scenarios, each voice profile of the plurality of predetermined voice profiles 130 may include one or more variants 134 having different levels of vocal brightness. In an example embodiment, the one or more variants include a warm variant or a bright variant. It will be understood that other voice profiles and/or stylistic vocal variants are possible and contemplated. In some alternative embodiments, instead of selecting the primary voice profile, it will be understood that the primary voice profile may be provided by a computing system (e.g., controller 150) or received by way of a communication interface.

In some embodiments, the operations could additionally or alternatively include selecting a default profile or configuration. As an example, the default profile could include a predetermined, user-preselected, and/or user-preferred voice profile. In such scenarios, the profile selection process could be skipped altogether.

The operations also include adjusting, based on the selected (or provided) primary voice profile, at least a portion of the source audio 142. In some example embodiments, adjusting the at least a portion of source audio 142 could include adjusting the portion of source audio based on a processing chain 160. In such scenarios, the processing chain 160 could include a plurality of audio processing modules 170. At least a portion of the audio processing modules 170 are configured to apply a trained machine learning model 120 to adjust the portion of source audio 142.

The operations additionally include providing output audio 140 based on the adjusted portion of source audio 142.

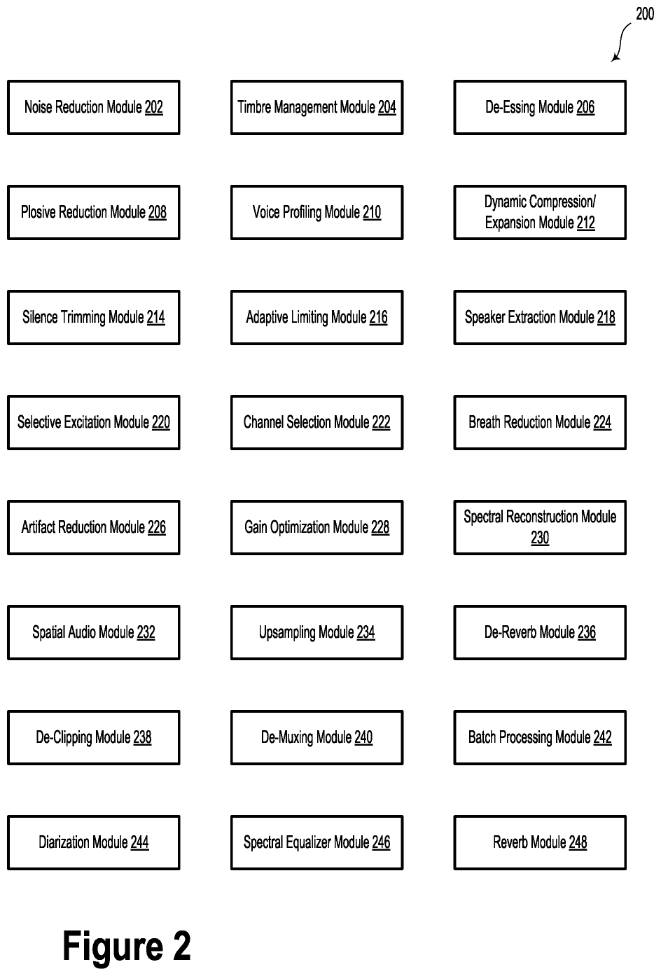

FIG. 2 illustrates audio processing modules 200, according to an example embodiment. As shown in FIG. 2, the audio processing modules 200 could include one or more application programming interfaces (APIs), methods, requests, and/or subroutines configured to carry out certain audio processing-related functions.

The audio processing modules 200 could include a noise reduction module 202 configured to remove noise from the source audio 110, pre-mix tracks, and/or mixed tracks. Potential noise sources could include thermal hiss, white noise, frequency-dependent noise, or other types of audio noise. Additionally, in various embodiments, noise reduction module 202 could remove non-vocal sounds from the recording (e.g. dog barks, crying babies, lawnmowers, traffic sounds, etc.).

The audio processing modules 200 could also include a timbre management module 204 configured to analyze characteristics of a speaker's voice and/or adjust the source audio 110 so as to more faithfully and/or desirably reproduce the timbre or other characteristics of a predetermined speaker's voice. As an example, microphones have a particular frequency response. Standard techniques are to manipulate the equalization curve to get a more characteristically “broadcast” sound (e.g. emphasizing the bass, de-emphasizing the nasal midrange, etc.). These techniques are best leveraged in a voice-specific manner. The systems and methods described herein are configured to learn the desired modifications to obtain more desirable, broadcast-quality audio and then adjusts the source recording to reproduce the desired characteristics.

The audio processing modules 200 could additionally include a de-essing module 206. The de-essing module 206 could be configured to remove, reduce, or compensate for sibilant consonants in the source audio 110. In some examples, sibilant consonants could include sounds normally represented in English by “s”, “z”, “ch”, “j” and “sh”, in recordings of the human voice.

In some embodiments, the audio processing modules 200 could additionally include a plosive reduction module 208. The plosive reduction module 208 could be configured to reduce or remove the prominence of vocal occlusive sounds. Such sounds may be caused by the expulsion of air from the mouth creating the plosive impacting a microphone's diaphragm. In the room, this can be inaudible to a listener. However, the microphone may register a low-frequency movement of air as a low-frequency spike in the recorded audio.

In various examples, the audio processing modules 200 may include a voice profiling module 210. The voice profiling module 210 could be configured to analyze one or more vocal tracks and classify those vocal tracks by various speech characteristics.

In some embodiments, the audio processing modules 200 can include a dynamic compression/expansion module 212 that could be configured to reduce the volume of loud sounds and/or make quiet sounds louder in the source audio 110. In general, dynamic compression/expansion module 212 could reduce a dynamic range of the source audio 110, which may provide a better listening experience because a speaker's vocal track volume will not have extreme loudness peaks and valleys within the mix.

A silence trimming module 214 could be included in the plurality of audio processing modules 200. In various examples, the silence trimming module 214 could be configured to splice or cut out some or all portions of the source audio 110 without speech.

In example embodiments, the audio processing modules 200 could include an adaptive limiting module 216. The adaptive limiting module 216 could be configured to attenuate a loudness level of one or more tracks of the source audio 110 when the level exceeds a predetermined threshold. In some scenarios, the adaptive limiting module 216 could be combined with gain to increase the overall loudness of a given track during the mixing and/or mastering process.

In various embodiments, the audio processing modules 200 could include a speaker extraction module 218. The speaker extraction module 218 could be configured to isolate or separate vocal tracks from one another and/or from other audio tracks in the source audio 110. In some embodiments, the speaker extraction module 218 could export vocal tracks to a separate audio processing chain for different audio adjustment as compared to the other portions of the source audio 110.

The audio processing modules 200 could include a selective excitation module 220. In various embodiments, the selective excitation module 220 could be configured to add audio saturation to higher frequency signals (e.g., 3 kHz and up). Such an effect may be applied in the processing chain 160 to provide more overtones, distortion, and/or richness as compared to the source audio 110. In some embodiments, the selective excitation module 220 may also be utilized to replace frequencies that were lost during the recording and/or prior processing.

In some examples, the audio processing modules 200 could include a channel selection module 222, which could perform multiple functions. For example, the channel selection module 222 could include: if a source file is delivered in stereo and has near identical content in each channel, the channel selection module 222 could select the dominant channel (e.g., the left channel) and discard the other one (e.g., the right channel). In such scenarios, the channel selection module 222 could beneficially avoid or reduce issues that may arise by mixing the two channels to mono. For example, potential issues include phasing or other undesirable artifacts. The channel selection module 222 could also identify if the channels represent different speakers and may process and subsequently mix them together as desired. In such scenarios, the channel selection module 222 could be configured to select and/or separate the vocal tracks from the remaining portions of the source audio 110. Once selected, the vocal tracks could undergo different audio signal processing as compared to the other portions of the source audio 110.

The audio processing modules 200 could additionally include a breath reduction module 224. In some embodiments, the breath reduction module 224 could be configured to remove or reduce human breath sounds from vocal tracks.

In various embodiments, the audio processing modules 200 could include an artifact reduction module 226. The artifact reduction module 226 may be configured to remove audio artifacts including those induced by audio compression and/or audio codecs, such as artifacts known as “swirlies.”

The plurality of audio processing modules 200 could include a gain optimization module 228. In such scenarios, the gain optimization module 228 could be utilized to get each voiceover recording in the same general volume “ballpark”. In some examples, in addition to traditional gain manipulation, the gain optimization module 228 could utilize signal limiting to allow for gain increases beyond unity. The gain optimization module 228 could be configured to dynamically adjust the level of the vocal and/or other tracks to improve or maximize signal bandwidth. Additionally or alternatively, the gain optimization module 228 could adjust the level of the source audio 110 to be approximately mid-way between the noise floor and the distortion or overload point. As such, the gain optimization module 228 could adjust the gain level in such a way to avoid clipping the audio signal.

In some examples, the audio processing modules 200 could include a spectral reconstruction module 230. In such scenarios, the spectral reconstruction module 230 could be configured to reconstruct higher audio frequency audio signals from source audio 110 that could lack such higher frequency content due to, for example, low quality, lossy audio recordings.

In various embodiments, the audio processing modules 200 could include a spatial audio module 232. For example, the spatial audio module 232 could be configured to adjust an apparent location of audio in a listener's acoustic soundstage. That is, the spatial audio module 232 could adjust the source audio 110, or portions thereof, to be perceivable as emanating from controllable locations or zones around the listener. In some examples, the spatial audio module 232 could enhance intelligibility of the source audio 110 by spatially localizing or otherwise enhancing an apparent location of one or more speakers around the listener. As such, the spatial audio module 232 could provide an immersive, 3-dimensional audio experience for the listener using either two-channel binaural encoding or a multi-channel format (such as Dolby Atmos).

In an example embodiment, the audio processing modules 200 could include an upsampling module 234. The upsampling module 234 could be configured to increase the bit rate of the source audio 110. In some examples, some tracks of the source audio 110 could be processed at a lower bit rate and then upsampled prior to output or mastering. In various embodiments, the upsampling module 234 could operate along with the spectral equalizer module 246. For example, the spectral equalizer module 246 and the upsampling module 234 could operate together so as to replace high-frequency components from audio previously determined to have attenuated high-frequency content.

In some embodiments, the audio processing module 200 could include a reverb module 248. The reverb module 248 could be configured to introduce a reverberation effect to the source audio 110 and/or re-introduce the reverberation effect to processed source audio 110. In various examples, the reverberation effect could include echo effects due to sound being absorbed and/or reflected from various actual or imaginary objects. The reverb module 248 could form the reverberation effect using digital processing or various analog reverb types, such as spring or plate reverb devices. The reverb module 248 could be utilized to add back in an appropriate amount of reverb, for example to match a desired reverb level in a portion of the source audio 110. It will be understood that other ways to apply reverberation effects to the source audio 110 are contemplated and possible.

In a further example, the audio processing module 200 could also include a de-reverb module 236. The de-reverb module 236 could be configured to remove the effects of reverberation from the source audio 110.

The audio processing modules 200 could include a de-clipping module 238. The de-clipping module 238 could be configured to restore or reconstruct distorted waveforms, for example, due to an overdriven amplifier, microphone, or improper gain staging during recording.

In various embodiments, the audio processing modules 200 could include a de-muxing module 240. The de-muxing module 240 could be configured to separate audio tracks from the source audio 110. In such scenarios, the de-muxing module 240 could route vocal components to a particular audio processing chain while other types of components are routed to another audio processing chain.

In some examples, the audio processing modules 200 could include a batch processing module 242. The batch processing module 242 could be configured to control the audio processing of a plurality of source audio 110 files. In some embodiments, the batch processing module 242 could be configured to process 10, 100, 1000, 10000 or more files in a parallel and/or serial fashion.

The plurality of audio processing modules 200 may include a diarization module 244. The diarization module 244 is configured to determine, based on the vocal portion 112, a plurality of distinct speakers 114. The diarization module 244 could also be configured to annotate portions of the vocal portion 112 that represent the respective distinct speakers 114.

The diarization module 244 is further configured to provide diary metadata 144. In such scenarios, the diary metadata could include information indicative of the distinct speakers 114 of the annotated portions of the vocal portion 112. Furthermore, the diarization module 244 could be also configured to provide a speaker-specific audio file 180 for each distinct speaker 114.

In some cases involving the diarization module 244, the operation of adjusting, based on the selected primary voice profile 132, the at least a portion of the source audio 110, could additionally include smoothing a perimeter portion of each speaker-specific audio file 180 and adjusting each speaker-specific audio file 180 separately. In such scenarios, the output audio 140 is formed from a reassembled version of each adjusted speaker-specific audio file.

The audio processing modules 200 could additionally or alternatively include a spectral equalizer module 246. In such embodiments, the spectral equalizer module 246 could be configured to adjust the volume of different frequency bands within the source audio 110. In some examples, the spectral equalizer module 246 could be configured to eliminate unwanted sounds (e.g., low frequency amplifier hum or high frequency overtones) or accentuate desired frequency bands. The spectral equalizer module 246 could also be utilized to adjust the frequency content of music and vocal tracks of the source audio 110. As an example, the spectral equalizer module 246 could adjust the source audio 110 to achieve an appropriate timbre for a given individual speaker based on a voice profile 132.

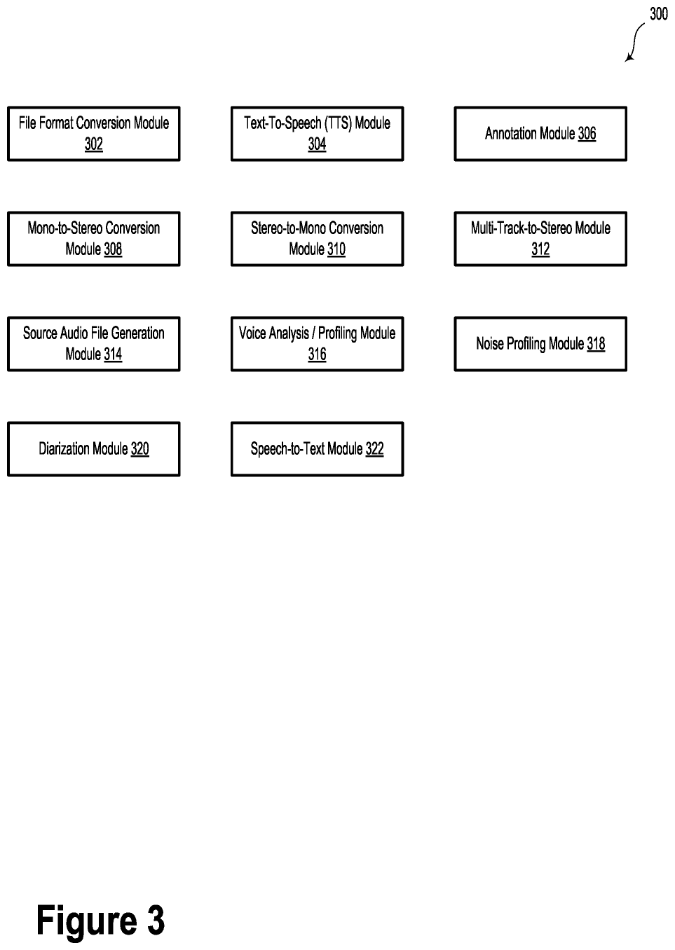

FIG. 3 illustrates pre-processing modules 300, according to an example embodiment. The pre-processing modules 300 could be in the form of one or more application programming interfaces (APIs), methods, requests, and/or subroutines configured to carry out certain data-and/or audio-processing-related functions.

As an example, the pre-processing modules 300 could include a file format conversion module 302. The source audio 110 could be provided in a variety of different file formats. For example, the source audio 110 could be in formats such as MP3, AAC, FLAC, OGG, WMA, WAV, and AIFF, among other possibilities. The file format conversion module 302 could be configured to convert the source audio 110 from a first file format to a second file format.

In some embodiments, the pre-processing modules 300 could include a text-to-speech module 304. The text-to-speech module 304 could be configured to convert text to spoken word speech audio. In an example, the text-to-speech module 304 could be operable to convert raw text into words based on a symbolic linguistic representation (e.g., text normalization). Furthermore, the text-to-speech module 304 could be operable to convert the symbolic linguistic representation into sound. In an example embodiment, the text-to-speech module 304 could be utilized to create audio content with one or more voices in a given recording, such as a two-host news media program, or another type of multi-speaker content. In some examples, conventional text-to-speech (TTS) models may undesirably replicate certain audio problems based on their imperfect training data (e.g., plosives, excessive sibilance, etc.). Such audio problems could be substantially equivalent to human-recorded speech with accompanying recording defects. In such scenarios, the systems and methods described herein may be utilized to beneficially correct/adjust the audio signal to remove the defects.

In various embodiments, the pre-processing modules 300 could include an annotation module 306. The annotation module 306 could be configured to analyze the source audio 110 and add tags that indicate various important aspects, such as cut points, speaker identity, bookmarks between audio sections, among other possibilities. In some examples, the annotation module 306 and a text segmentation module (not shown) may work together to thematically annotate various sections of the recording.

The pre-processing modules 300 could include a mono-to-stereo conversion module 308. The mono-to-stereo conversion module 308 could be configured to convert a single-channel (mono) source audio track into a two-channel (stereo) audio track.

In some embodiments, the pre-processing modules 300 may include a stereo-to-mono conversion module 310. The stereo-to-mono conversion module 310 could be configured to convert a two-channel (stereo) source audio track into a one-channel (mono) audio track.

In various examples, the pre-processing modules 310 could include a multi-track-to-stereo conversion module 312. The multi-track-to-stereo conversion module 312 could be configured to convert a multi-channel source audio track into a two-channel (stereo) audio track.

As an example, the pre-processing modules 300 may include a source audio file generation module 314. The source audio file generation module 314 could be configured to generate random or desired source audio files.

In some examples, the pre-processing modules 300 could include a voice analysis/profiling module 316. The voice analysis/profiling module 316 may be configured to analyze the source audio 110 and provide information indicative of distinct speakers 114. In some embodiments, the voice analysis/profiling module 316 may also be configured to compare the characteristics of voices of the distinct speakers 114 with predetermined voice profiles 130. Yet further, the voice analysis/profiling module 316 might be configured to classify the distinct speakers 114 as a primary voice profile 132 and/or one or more voice profile variants 134.

As an example, the pre-processing modules 300 could include a noise profiling module 318. The noise profiling module 318 may be configured to analyze the noise characteristics of the source audio 110 and provide information indicative of one or more types of the audio noise present in the source audio 110.

In some cases, the pre-processing modules 300 could include a diarization module 320, which could be similar or identical to the diarization module 244, as described in relation to FIG. 2.

In various example embodiments, the pre-processing modules 300 could include a speech-to-text module 322. The speech-to-text module 322 could be a speech recognition device configured to analyze a person's speech and convert it to text characters. In some examples, the speech-to-text module 322 could include a Hidden Markov model. Additionally or alternatively, the speech-to-text module 322 could be based on a neural network (e.g., for phoneme classification) or a dynamic time warping (DTW)-based speech recognition system. In such scenarios, the speech-to-text module 322 could be configured to carry out a text segmentation function. The text segmentation function could include separating or annotating the text content based on the speaker. For example, the speech-to-text module 322 could be configured to analyze a two-person podcast episode and provide a transcript that identifies and distinguishes between the words spoken by Speaker A and Speaker B.

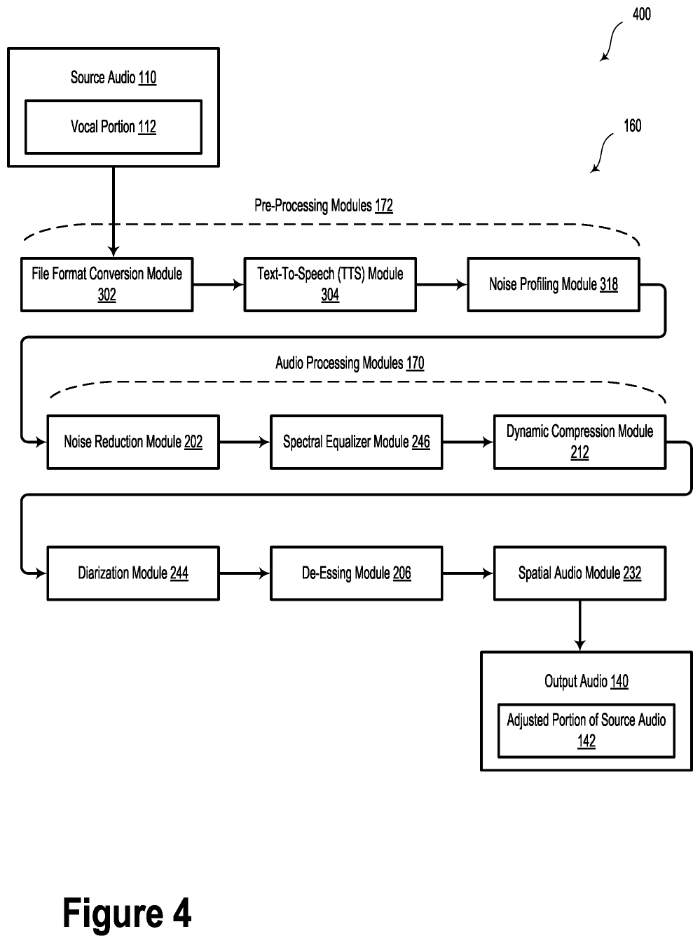

FIG. 4 illustrates a scenario 400 that includes a processing chain 160 with a plurality of pre-processing modules 172 and a plurality of audio processing modules 170, according to an example embodiment. As illustrated in FIG. 4, the processing chain 160 could include a source audio 110 having a vocal portion 112. The source audio 110 could undergo pre-processing by way of the pre-processing modules 172. Namely, the pre-processing modules 172 could include the file format conversion module 302, the TTS Module 304, and the noise profiling module 318. Thereafter, the intermediate audio content could be processed via the audio processing modules 170, such as the noise reduction module 202, spectral equalizer module 246, dynamic compression/expansion module 212, diarization module 244, de-essing module 206, and the spatial audio module 232. Afterward, the audio content could be output 140 from the audio preparation and delivery system 100 to another system or device.

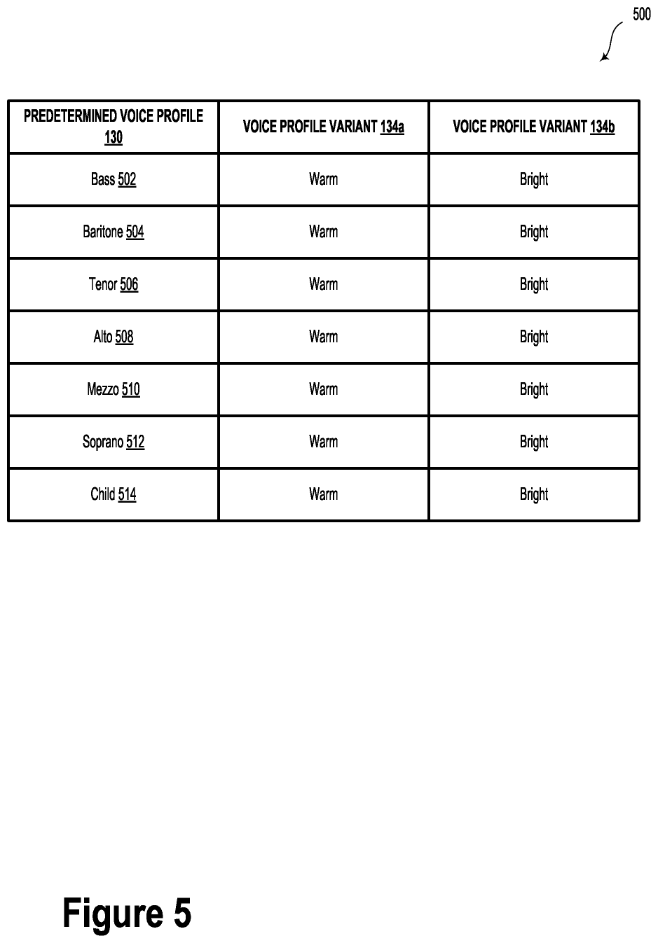

FIG. 5 illustrates a chart including a plurality of predetermined voice profiles 130, according to an example embodiment. As an example, the plurality of predetermined voice profiles 130 could include at least one of: bass 502, baritone 504, tenor 506, alto 508, mezzo 510, soprano 512, or child 514. In such scenarios, each voice profile of the plurality of predetermined voice profiles 130 could include one or more variants 134 having different levels of vocal brightness. In an example embodiment, the one or more variants include a warm variant 134a or a bright variant 134b. Additionally or alternatively, the plurality of predetermined voice profiles 130 could include various vocal styles, such as radio DJ, newscaster, podcaster, among other profiles. In some embodiments, predetermined voice profiles 130 could include very specific, sometimes individually personalized, speaker-specific profiles-e.g. “Neil A” “Sally R” . . . and even more specific “Yuri G-Overnights” or “Yuri G-Afternoons”. Other variants are possible.

In some embodiments, the audio preparation and delivery system 100 could include at least one of: a private cloud computing server system or a public cloud computing server, wherein the private cloud computing server system and the public cloud computing server comprise distributed cloud data storage and distributed cloud computing capacity. Furthermore, various operations of the audio preparation and delivery system 100 could be performed by the public cloud computing server system or the private cloud computing server system.

The audio preparation and delivery system of claim 1, wherein the trained machine learning model comprises at least one of: a convolutional neural network (CNN), a long short-term memory (LSTM) algorithm, or a WaveNet.

### III. Example Methods

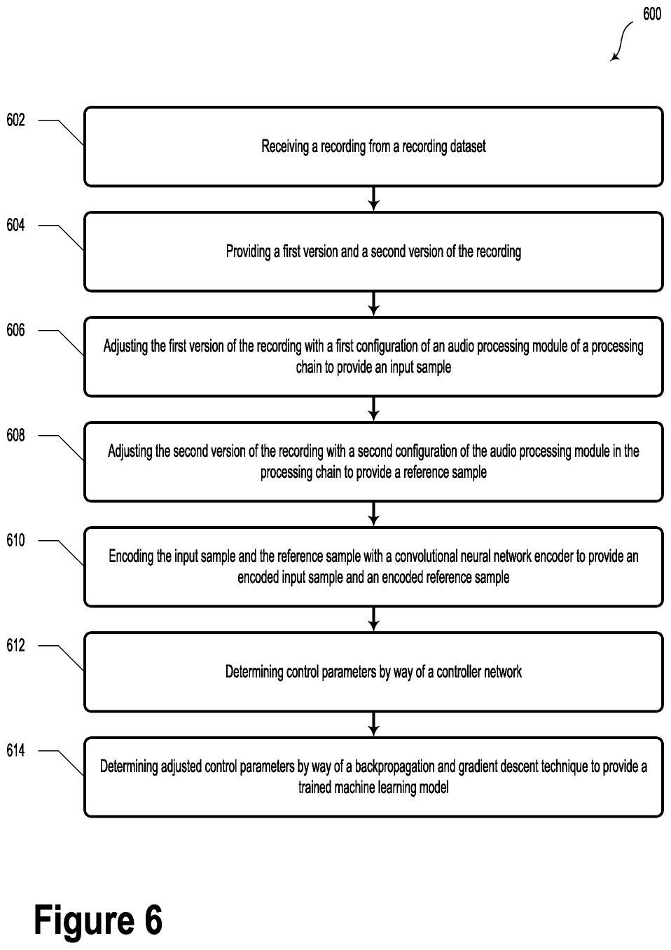

FIG. 6 illustrates a method 600 of training a machine learning model, according to an example embodiment. While method 600 illustrates several blocks of an example method, it will be understood that more blocks or steps could be included. In such scenarios, at least some of the various blocks or steps may be carried out in a different order than of that presented herein. Furthermore, blocks or steps may be added, subtracted, transposed, and/or repeated. Some or all of the blocks or steps of method 600 may be carried out by controller 150, as illustrated and described in reference to FIG. 1, and/or other computing devices.

Block 602 includes receiving a recording from a recording dataset.

Block 604 includes providing a first version and a second version of the recording.

Block 606 includes adjusting the first version of the recording with a first configuration of an audio processing module of a processing chain to provide an input sample.

Block 608 includes adjusting the second version of the recording with a second configuration of the audio processing module in the processing chain to provide a reference sample.

Block 610 includes encoding the input sample and the reference sample with a convolutional neural network encoder to provide an encoded input sample and an encoded reference sample.

Block 612 includes determining control parameters by way of a controller network.

Block 614 includes determining adjusted control parameters by way of a backpropagation and gradient descent technique to provide a trained machine learning model.

In some example embodiments, method 600 may also include determining a short-time Fourier transform (STFT) of the input sample. In such scenarios, the method 600 may also include determining a STFT of the reference sample. In some embodiments, encoding the input sample and the reference sample could include encoding the STFT of the input sample and the STFT of the reference sample.

In various embodiments, the controller network could include a multi-layer perceptron (MLP). In such scenarios, the operations of block 612 could be performed by the multi-layer perceptron.

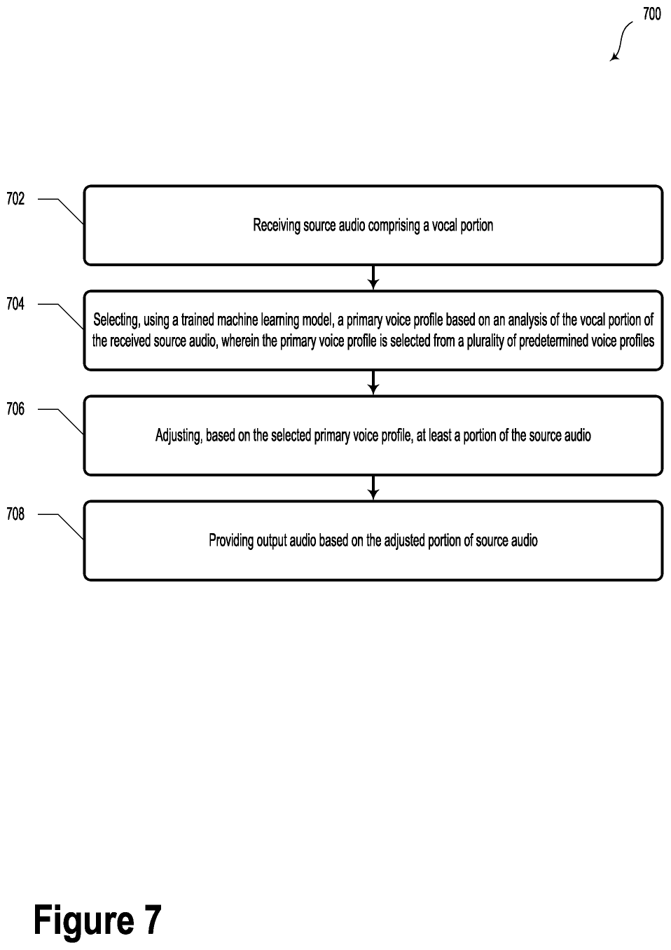

FIG. 7 illustrates a method 700 of adjusting source audio, according to an example embodiment. While method 700 illustrates several blocks of an example method, it will be understood that more blocks or steps could be included. In such scenarios, at least some of the various blocks or steps may be carried out in a different order than of that presented herein. Furthermore, blocks or steps may be added, subtracted, transposed, and/or repeated. Some or all of the blocks or steps of method 700 may be carried out by controller 150, as illustrated and described in reference to FIG. 1, and/or other computing devices.

Block 702 includes receiving source audio (e.g., source audio 110) having a vocal portion (e.g., vocal portion 112).

Block 704 includes selecting, using a trained machine learning model (e.g., trained machine learning model 120), a primary voice profile (e.g., primary voice profile 132) based on an analysis of the vocal portion of the received source audio. The primary voice profile is selected from a plurality of predetermined voice profiles (e.g., predetermined voice profiles 130).

Block 706 includes adjusting, based on the selected primary voice profile, at least a portion of the source audio (e.g., adjusted portion of source audio 142).

Block 708 includes providing output audio (e.g., output audio 140) based on the adjusted portion of source audio.

In some example embodiments, the plurality of predetermined voice profiles could include at least one of: bass, baritone, tenor, alto, mezzo, soprano, or child. In such scenarios, each voice profile of the plurality of predetermined voice profiles could include one or more variants (e.g., voice profile variants 134) having different levels of vocal brightness. As an example, the one or more variants could include a warm variant or a bright variant.

In various examples, adjusting the at least a portion of source audio may include adjusting the portion of source audio based on a processing chain (e.g., processing chain 160). In such scenarios, the processing chain could include a plurality of audio processing modules (e.g., audio processing modules 170). In some examples, at least a portion of the audio processing modules could be configured to apply a trained machine learning model (e.g., trained machine learning model 120) to adjust the portion of source audio.

As described elsewhere herein, the plurality of audio processing modules could include a noise reduction module 202, a timbre management module 204, a de-essing module 206, a plosive reduction module 208, a voice profiling module 210, a dynamic compression/expansion module 212, a silence trimming module 214, an adaptive limiting module 216, a speaker extraction module 218, a selective excitation module 220, a channel selection module 222, a breath reduction module 224, an artifact reduction module 226, a gain optimization module 228, a spectral reconstruction module 230, a spatial audio module 232, an upsampling module 234, a de-reverb module 236, a de-clipping module 238, a de-muxing module 240, a batch processing module, 242, and a spectral equalizer module 246, among other possibilities.

In some example embodiments, the plurality of audio processing modules could include a diarization module (e.g., diarization module 244). In such examples, the diarization module is configured to determine, based on the vocal portion, a plurality of distinct speakers. The diarization module is also configured to annotate portions of the vocal portion that represent the respective distinct speakers. The diarization module is additionally configured to provide diary metadata. In such scenarios, the diary metadata could include information indicative of the distinct speakers of the annotated portions of the vocal portion. The diarization module could additionally be configured to provide a speaker-specific audio file for each distinct speaker.

In various examples, the adjusting, based on the selected primary voice profile, the at least a portion of the source audio, could include smoothing a perimeter portion of each speaker-specific audio file. Furthermore, the adjusting step could include adjusting each speaker-specific audio file separately. In such a scenario, the output audio includes a reassembled version of each adjusted speaker-specific audio file.

In some example embodiments, the processing chain may additionally include one or more pre-processing modules (e.g., pre-processing modules 172). In some examples, the pre-processing modules could include a file format conversion module 302, a text-to-speech (TTS) module 304, an annotation module 306, a mono-to-stereo conversion module 308, a stereo-to-mono conversion module 310, a multi-track-to-stereo conversion module 312, a source audio file generation module 314, a voice analysis/profiling module 316, a noise profiling module 318, or a diarization module 320.

The particular arrangements shown in the Figures should not be viewed as limiting. It should be understood that other embodiments may include more or less of each element shown in a given Figure. Further, some of the illustrated elements may be combined or omitted. Yet further, an illustrative embodiment may include elements that are not illustrated in the Figures.

A step or block that represents a processing of information can correspond to circuitry that can be configured to perform the specific logical functions of a herein-described method or technique. Alternatively or additionally, a step or block that represents a processing of information can correspond to a module, a segment, or a portion of program code (including related data). The program code can include one or more instructions executable by a processor for implementing specific logical functions or actions in the method or technique. The program code and/or related data can be stored on any type of computer readable medium such as a storage device including a disk, hard drive, or other storage medium.

The computer readable medium can also include non-transitory computer readable media such as computer-readable media that store data for short periods of time like register memory, processor cache, and random access memory (RAM). The computer readable media can also include non-transitory computer readable media that store program code and/or data for longer periods of time. Thus, the computer readable media may include secondary or persistent long term storage, like read only memory (ROM), optical or magnetic disks, compact-disc read only memory (CD-ROM), for example. The computer readable media can also be any other volatile or non-volatile storage systems. A computer readable medium can be considered a computer readable storage medium, for example, or a tangible storage device.

While various examples and embodiments have been disclosed, other examples and embodiments will be apparent to those skilled in the art. The various disclosed examples and embodiments are for purposes of illustration and are not intended to be limiting, with the true scope being indicated by the following claims.

What is claimed is:

1. An audio preparation and delivery system, comprising:
a controller having at least one processor and a memory, wherein the at least one processor executes program instructions stored in the memory so as to carry out operations, the operations comprising:
receiving source audio comprising a vocal portion;
selecting, using a trained machine learning model, a primary voice profile based on an analysis of the vocal portion of the received source audio, wherein the primary voice profile is selected from a plurality of predetermined voice profiles;
adjusting, based on the selected primary voice profile, at least a portion of the source audio; and
providing output audio based on the adjusted portion of source audio.

2. The audio preparation and delivery system of claim 1, wherein the plurality of predetermined voice profiles comprise at least one of: a speaker-specific profile, bass, baritone, tenor, alto, mezzo, soprano, or child.

3. The audio preparation and delivery system of claim 2, wherein each voice profile of the plurality of predetermined voice profiles comprise one or more variants having different levels of vocal brightness, wherein the one or more variants comprise a warm variant or a bright variant.

4. The audio preparation and delivery system of claim 1, wherein adjusting the at least a portion of source audio comprises adjusting the portion of source audio based on a processing chain, wherein the processing chain comprises a plurality of audio processing modules, wherein at least a portion of the audio processing modules are configured to apply a trained machine learning model to adjust the portion of source audio.

5. The audio preparation and delivery system of claim 4, wherein the plurality of audio processing modules further comprises at least one of:
a noise reduction module;
a timbre management module;
a de-essing module;
a plosive reduction module;
a voice profiling module;
a dynamic compression module;
a silence trimming module;
an adaptive limiting module;
a speaker extraction module;
a selective excitation module;
a channel selection module;
a breath reduction module;
an artifact reduction module;
a gain optimization module;
a spectral reconstruction module;
a spectral equalizer module;
a spatial audio module;
an upsampling module;
a reverb module;
a de-reverb module;
a de-clipping module;
a de-muxing module; and
a batch processing module.

6. The audio preparation and delivery system of claim 4, wherein the plurality of audio processing modules comprises:
a diarization module, wherein the diarization module is configured to:
determine, based on the vocal portion, a plurality of distinct speakers;
annotate portions of the vocal portion that represent the respective distinct speakers;
provide diary metadata, wherein the diary metadata comprises information indicative of the distinct speakers of the annotated portions of the vocal portion; and
provide a speaker-specific audio file for each distinct speaker.

7. The audio preparation and delivery system of claim 6, wherein the adjusting, based on the selected primary voice profile, the at least a portion of the source audio, comprises:
smoothing a perimeter portion of each speaker-specific audio file; and
adjusting each speaker-specific audio file separately, wherein the output audio comprises a reassembled version of each adjusted speaker-specific audio file.

8. The audio preparation and delivery system of claim 1, further comprising one or more pre-processing modules, wherein the pre-processing modules comprise at least one of:
a file format conversion module;
a text-to-speech module;
a speech-to-text module;
an annotation module;
a mono-to-stereo conversion module;
a stereo-to-mono conversion module;
a multi-track-to-stereo conversion module;
a source audio file generation module;
a voice analysis/profiling module;
a noise profiling module; and
a diarization module.

9. The audio preparation and delivery system of claim 1, wherein the audio preparation and delivery system comprises at least one of: a private cloud computing server system or a public cloud computing server, wherein the private cloud computing server system and the public cloud computing server comprise distributed cloud data storage and distributed cloud computing capacity.

10. The audio preparation and delivery system of claim 1, wherein the trained machine learning model comprises at least one of: a convolutional neural network (CNN), a long short-term memory (LSTM) algorithm, or a WaveNet.

11. A method of training a machine learning model, the method comprising:
receiving a recording from a recording dataset;
providing a first version and a second version of the recording;
adjusting the first version of the recording with a first configuration of an audio processing module of a processing chain to provide an input sample;
adjusting the second version of the recording with a second configuration of the audio processing module in the processing chain to provide a reference sample;
encoding the input sample and the reference sample with a convolutional neural network encoder to provide an encoded input sample and an encoded reference sample;
determining control parameters by way of a controller network; and
determining adjusted control parameters by way of a backpropagation and gradient descent technique to provide a trained machine learning model.

12. The method of claim 11, further comprising:
determining a short-time Fourier transform (STFT) of the input sample; and
determining a STFT of the reference sample, wherein encoding the input sample and the reference sample comprises encoding the STFT of the input sample and the STFT of the reference sample.

13. The method of claim 11, further comprising:
generating one or more metrics based on at least one of the first version or the second version of the recording, wherein the one or more metrics comprise at least one of: amplitude over time, pitch of utterance, onset of sound events, which speaker is talking, when the speakers pause, when the speakers take breaths, or a frequency response of the respective version of the recording, wherein adjusting the first version of the recording or adjusting the second version of the recording are based on the one or more metrics.

14. A method of adjusting source audio, the method comprising
receiving source audio comprising a vocal portion;
selecting, using a trained machine learning model, a primary voice profile based on an analysis of the vocal portion of the received source audio, wherein the primary voice profile is selected from a plurality of predetermined voice profiles;
adjusting, based on the selected primary voice profile, at least a portion of the source audio; and
providing output audio based on the adjusted portion of source audio.

15. The method of claim 14, wherein the plurality of predetermined voice profiles comprise at least one of: a speaker-specific profile, bass, baritone, tenor, alto, mezzo, soprano, or child, wherein each voice profile of the plurality of predetermined voice profiles comprise one or more variants having different levels of vocal brightness, wherein the one or more variants comprise a warm variant or a bright variant.

16. The method of claim 14, wherein adjusting the at least a portion of source audio comprises adjusting the portion of source audio based on a processing chain, wherein the processing chain comprises a plurality of audio processing modules, wherein at least a portion of the audio processing modules are configured to apply a trained machine learning model to adjust the portion of source audio.

17. The method of claim 16, wherein the plurality of audio processing modules further comprises at least one of:
a noise reduction module;
a timbre management module;
a de-essing module;
a plosive reduction module;
a voice profiling module;
a dynamic compression module;
a silence trimming module;
an adaptive limiting module;
a speaker extraction module;
a selective excitation module;
a channel selection module;
a breath reduction module;
an artifact reduction module;
a gain optimization module;
a spectral reconstruction module;
a spectral equalizer module;
a spatial audio module;
an upsampling module;
a reverb module;
a de-reverb module;
a de-clipping module;
a de-muxing module; and
a batch processing module.

18. The method of claim 16, wherein the plurality of audio processing modules comprises:
a diarization module, wherein the diarization module is configured to:
determine, based on the vocal portion, a plurality of distinct speakers;
annotate portions of the vocal portion that represent the respective distinct speakers;
provide diary metadata, wherein the diary metadata comprises information indicative of the distinct speakers of the annotated portions of the vocal portion; and
provide a speaker-specific audio file for each distinct speaker.

19. The method of claim 18, wherein the adjusting, based on the selected primary voice profile, the at least a portion of the source audio, comprises:
smoothing a perimeter portion of each speaker-specific audio file; and
adjusting each speaker-specific audio file separately, wherein the output audio comprises a reassembled version of each adjusted speaker-specific audio file.

20. The method of claim 16, wherein the processing chain further comprises one or more pre-processing modules, wherein the pre-processing modules comprise at least one of:
a file format conversion module;
a text-to-speech module;
a speech-to-text module;
an annotation module;
a mono-to-stereo conversion module;
a stereo-to-mono conversion module;
a multi-track-to-stereo conversion module;
a source audio file generation module;
a voice analysis/profiling module;
a noise profiling module; and
a diarization module.
